(19) United States
(12) Patent Application Publication
(10) Pub. No.: US 2015/0294449 A1
(43) Pub. Date: Oct. 15, 2015

(54) DETECT EDGE CHIP

(71) Applicant: TEXAS INSTRUMENTS INCORPORATED, Dallas, TX (US)

(72) Inventors: Paul Edward RHEINHEIMER, Tucson, AZ (US); Terry Elkin LA FLEUR, McKinney, TX (US)

(21) Appl. No.: 14/253,571

(22) Filed: Apr. 15, 2014

(51) Int. Cl. G06T 7/00; H04N 7/18

(52) U.S. Cl. CPC G06T 7/0004; H04N 7/183; G06T 2207/10004; G06T 2207/30148; G06T 2207/10052

(57) ABSTRACT

A system includes a support platform, a light source, a computing device coupled to the stage and the camera. The support platform is configured to support and move a wafer, and the light source is configured to shine an illuminating light on the wafer. The computing device is configured to detect a defect of the wafer by processing the acquired image and determining whether a signal of the acquired image is greater than a threshold. If the computing device detects the presence of the defect, the computing device is configured to generate an alarm.

### CROSS-REFERENCE TO RELATED APPLICATION

None.

### BACKGROUND

A defect in a semiconductor device, induced for example during fabrication, is common in the semiconductor manufacturing industry. With knowledge of the cause of the defect, a solution can be implemented to reduce or eliminate the defect.

### SUMMARY

Systems and methods to detect a defect of a wafer are disclosed herein. In an embodiment, a system includes a support platform, a light source, a computing device coupled to the stage and the camera. The support platform is configured to support and move a wafer, and the light source is configured to shine an illuminating light on the wafer. The computing device is configured to detect a defect of the wafer by processing the acquired image and determining whether a signal of the acquired image is greater than a threshold. If the computing device detects the presence of the defect, the computing device is configured to generate an alarm.

In another embodiment, a method includes moving a wafer, illuminating the wafer with a light source, processing the image to provide a distribution of a signal as a function of a corresponding location of the wafer, and detecting whether a processed signal corresponding to a location of the wafer is greater than a threshold.

In accordance with a further embodiment, a non-transitory, computer readable storage device includes executable instructions. When the instructions is executed by a processor, the processor is configured to move a wafer supported by a supporting platform, acquire an image of the wafer via an camera, process the acquired image to generate a distribution of a signal as a function of an associated location of the wafer, and detect a presence of a defect based on the generated signal at the associated location on the wafer being greater than a threshold. If the presence of the defect exists, the processor executes the instruction to generate an alarm.

### BRIEF DESCRIPTION OF THE DRAWINGS

For a detailed description of exemplary embodiments of the invention, reference will now be made to the accompanying drawings in which:

FIG. 1 shows a system to detect a defect of a wafer in accordance with various embodiments;

FIG. 2a-2e show examples of acquired images of a wafer and processed signals corresponding to the acquired images in accordance with various embodiments;

FIG. 3 shows an example of a defect detection engine in accordance with various embodiments; and

FIG. 4 shows a method to detect a defect by a defect detection engine in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . .” Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In order to remain competitive in the integrated circuit (IC) industry, IC process engineers may need to continuously increase device yield per wafer or lot. In other words, it is desirable to increase the number of usable semiconductor devices per wafer. Since any step in a multi-step flow of a fabrication process may affect the device yield, the IC process engineers may desire to be made aware of a particular step in which the device yield decreases to an intolerable threshold. The principles discussed herein help to identify where, if at all, in a fabrication process, wafer defects may be occurring.

Generally, a defect induced during the fabrication process may have a critical impact to the device yield. Some of the defects at or near the outer edge of a wafer may directly result from any one of the steps of the fabrication processes, and more particularly, a process associated with mechanical processing. For example, when a wafer is diced, chipping may occur along the dicing edges of an individual IC device. Such chipping may then lead to a formation of cracks throughout the IC device and cause the IC device to be unusable for its intended application. That is, the chipping results in IC devices that may be more vulnerable to stress and more susceptible to damage. As a result of an increase in unusable IC devices due to chipping, the IC device yield per wafer or lot is significantly reduced, and product reliability is compromised.

Thus, systems and methods that are useful to detect a presence of defects on the wafer immediately after each step in the process flow may advantageously result in an increase of the yield, and in turn increase the product reliability. If numerous defects are detected at a particular point in the processing flow, then attention can be paid to the that particular process step and a diagnose of the cause of the detects may be made.

Embodiments of the present disclosure provide a system and a method that concurrently monitor a wafer being processed after each step in the fabrication flow, and further detect a presence of a defect on the edges of the wafer by continuously acquiring images of the wafer via a complementary metal oxide semiconductor (CMOS) camera. The disclosed embodiments advantageously allow a user (e.g., a process engineer) to identify or otherwise be informed of defects which may subsequently causes a decrease of the device yield.

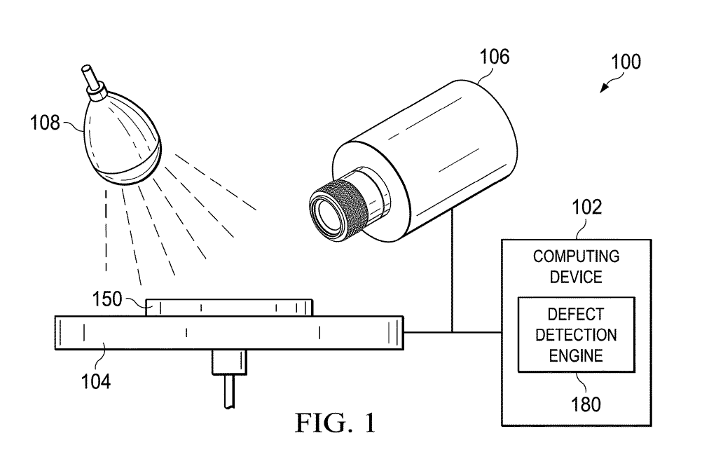

FIG. 1 shows a block diagram of a system 100 to detect a defect in accordance with various embodiments. The system 100 includes a computing device 102, a support platform 104, a camera 106, a light source 108, and a wafer 150 to be examined for a possible edge defect. As shown in FIG. 1, the computing device 102 further includes a defect detection engine 180. In some preferred embodiments, the wafer 150 is attached to the support platform 104 via an adherence force induced by vacuum provided by the support platform 104. The support platform may cause the wafer 150 to be moved in a circular motion. The light source 108 is configured to provide illuminating light to the wafer 150 so as to enable the camera 106 to acquire an image of the wafer 150. The light source 108 can be, for example, an ambient light source, a laser configured to emit illuminating light or continuous wave light.

Still referring to FIG. 1, the support platform 104 and the camera 106 are coupled to the computing device 102. More specifically, the defect detection engine 108 in the computing device 102 is configured to control the camera 106 and the support platform 104. For example, the defect detection engine 108 may control whether the wafer 150 is moved in a circular motion and also to control the speed of the motion (e.g., how fast the wafer rotates).

While the wafer 150 is moving, the defect detection engine causes the camera 106 to acquire images of at least a portion of the wafer. The defect detection engine 180 preferably determines a periodicity for the acquisition of images by the camera. That is, the defect detection engine determines a time interval between successive images acquired by the camera (e.g., between a first image and a subsequently acquired second image). After the camera 106 acquires a first image of the wafer 150, and the first image corresponds to a first location on the wafer, the camera 106 may wait for the time interval determined by the defect detection engine 108 to acquire the next (second) image. The second image corresponds to a second location on the wafer 150. As such, in a preferred embodiment, the defect detection engine 108 may require the camera 106 to acquire at least two images of the wafer 150.

After the camera 106 acquires the images, the computing device 102 may store the acquired images in a storage device. The defect detection engine 180 is configured to process the acquired images and thereby generate a graph representing a processed signal (e.g., intensity of reflected light from the wafer) as a function of corresponding location on the wafer 150. Details of the processing on the acquired images will be explained below.

In a preferred embodiment, the camera 106 may be a CMOS camera, a charged-coupled device (CCD) camera, a hybrid of CMOS and CCD camera, or other types of image sensors in any suitable applications. That is, the camera 106 may include a CMOS sensor that is configured to capture light and convert the captured light into electrical signals (e.g., voltage). Further, the electrical signals may be converted into digital data by an image processing engine (e.g., defect detection engine 180).

In some preferred embodiments, the camera 106 is configured to capture diffusely reflected light from the wafer 150. Diffusely reflected light refers to light that is reflected by the wafer 150 at a variety of angles due to an imperfect surface (e.g., roughness) on the wafer 150. As such, the reflected light from each location of the wafer 150 that is captured by the camera 106 may possess different light intensity.

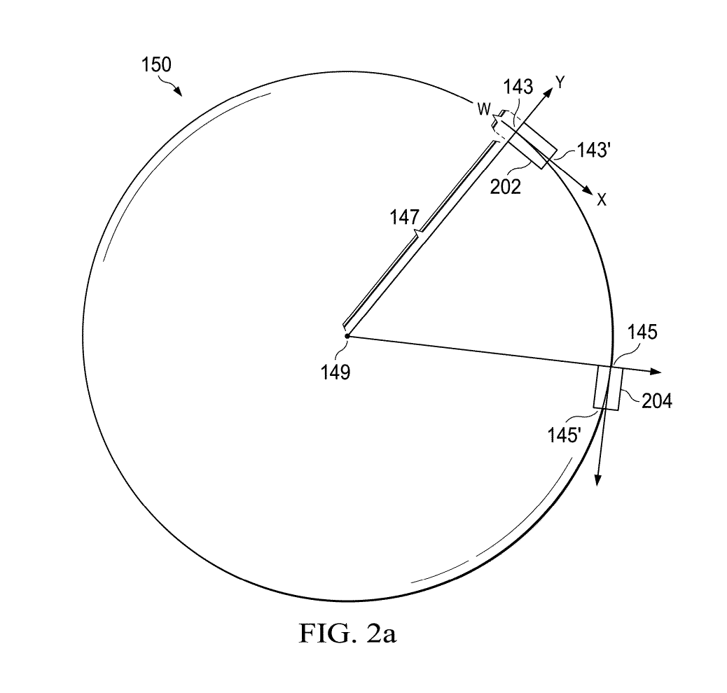

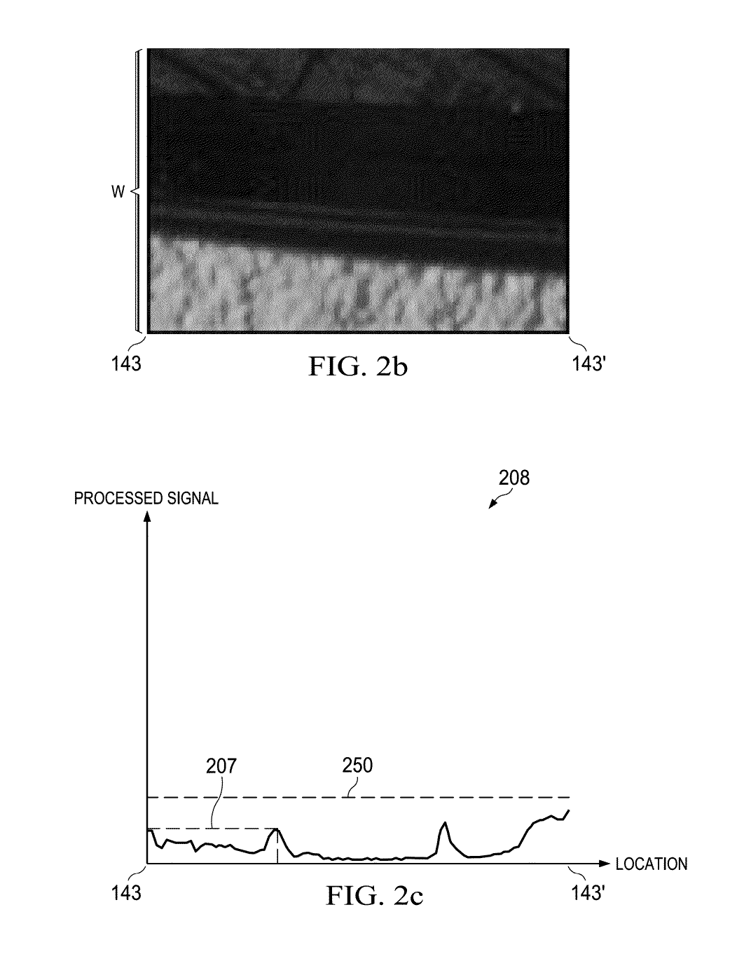

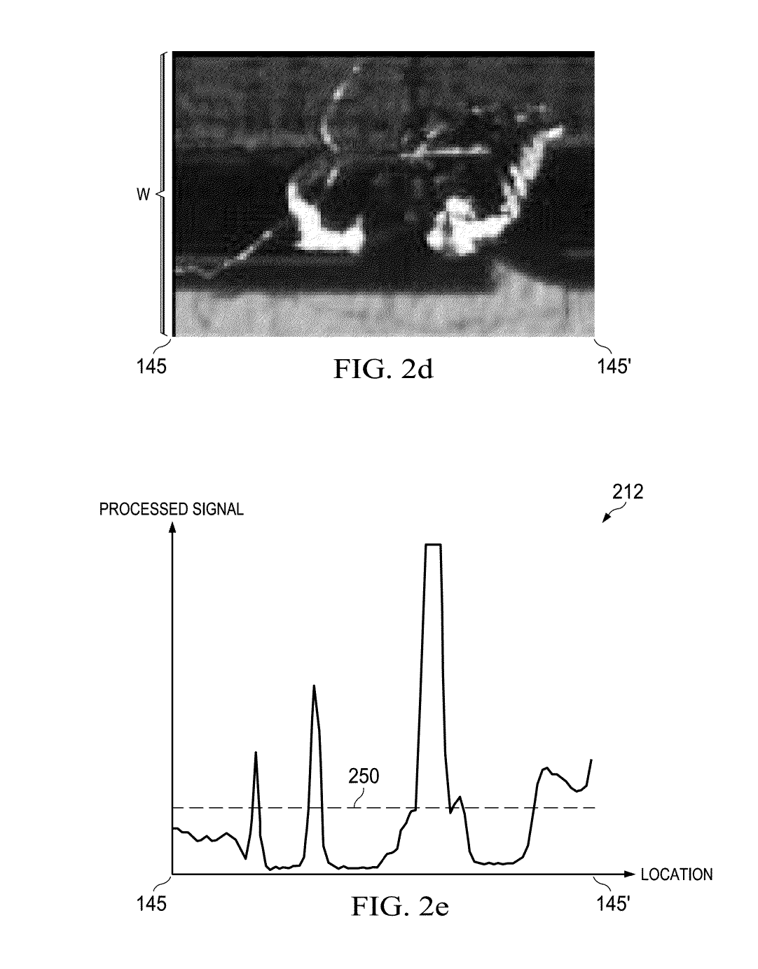

FIGS. 2b-2e show examples of the images captured by the camera 106 (FIGS. 2b and 2d) and associated graphs (FIGS. 2c and 2e) plotting a digital signal as a function of corresponding wafer location as processed by the defect detection engine 180. In a preferred embodiment, FIGS. 2c and 2e may not be generated and shown in a display unit. FIG. 2a shows the wafer 150, detected by the computing device 102, including two areas 202 and 204 whose images have been acquired by the camera 106. Although, in some preferred embodiments, the two areas 202 and 204 as shown in FIG. 2a may be on the edges of the wafer 150, the areas 202 and 204 may be anywhere on the wafer 150. Further, for a purpose of clear recognition, the area 202 is identified as a rectangle, wherein a length of the rectangle extends from point 143 and ends at 143′ (e.g., x-axis in FIG. 2a), and a width of the rectangle is “W” (e.g., y-axis in FIG. 2a) that may be determined by the defect detection engine 180. In some preferred embodiments, the point 143 is defined as a starting point for a first area (e.g., 202) whose image is acquired by the camera 106. The point 143 is preferably on the edge of the wafer 150 and thus the point 143 is separate from a center 149 of the wafer 150 with a distance 147. The distance is a radius of the wafer 150. Similarly, the area 204 includes a rectangle having a starting point 145 and an ending point 145. Additionally, in FIG. 2a, the area 202 is separated by a distance from the area 204, but these two areas 202 and 204 may be adjacent.

FIG. 2b shows image 206 acquired by camera 106 at area 202 of the wafer. FIG. 2c shows a graph 208 presenting a processed signal as a function of corresponding location for the acquired image 206. Similarly, FIG. 2d shows image 210 acquired by the camera at area 204 of the wafer, and FIG. 2e shows a graph 212 of the processed signal as a function of corresponding location for the acquired image 210. As labeled in the FIG. 2b˜2e, the numerals 143, 143, 145 and 145 represent the edges of the rectangles in area 202 and 204 respectively. For example, the image 206 includes a left edge 143 and a right edge 143, x-axis of the graph 208 starts from 143 to 143.

In some preferred embodiments, the processed signal in each of FIGS. 2c and 2e may be an electrical signal converted by the CMOS sensor in the camera 106, or digital data provided by the defect detection engine 180. More specifically, the processed signal may be a digital, modulated, or coded signal, which is a conversion of an analog signal received by the camera 106, and the analog signal may be a photoluminescence resulting from the reflection. Regardless of whether the processed signal is generated and/or retrieved via the CMOS sensor or the defect detection engine, the processed signal is associated with the light intensity reflected from the wafer 150.

In the examples of FIGS. 2b and 2d, there is no defect (e.g., edge chip) in area 202 on the wafer but there is a defect in area 204. As such, image 206 in FIG. 2b shows a control image as indicated by the graphed process signal being below a threshold 250 in FIG. 2c. In 208, the y-axis represents the processed signal (e.g., electrical signal or digital signal) and the x-axis represents the corresponding location within the area 202. For example, reference numeral 207 identifies a particular physical point on the edge of the wafer within the area 202. Reference numeral 209 represents the magnitude of the processed signal (e.g., intensity of the reflected light) from the physical point 207. Further, in a preferred embodiment, the defect detection engine 180 defines a threshold value 250 to determine whether a defect exists in an acquired image. More particularly, if the processed signal is greater than the threshold 250, then the defect detection engine 180 may determine that a defect is present in the image. As can be seen in FIG. 2c, the processed signal never exceeds threshold 250 and thus, the defect detection engine 180 concludes that no defect is present in image 206 and thus at location 202 on the wafer.

In the graph of FIG. 2e, however, several peaks of the processed signal exceed threshold 250. As such, the defect detection engine 180 may determine that, in area 204, one or more defects are present. As described above, the graph 208 and 212 may not be generated and shown in a display unit. In a preferred embodiment, the defect detection engine 180 may generate the processed signal and store the processed signal (e.g., 209) associated with the corresponding location (e.g., 207) in a storage device unit so that the defect detection engine 180 may compare whether a processed signal corresponding to a particular location is greater than the threshold (e.g., 250) by implementing a signal processing, such as searching a lookup table.

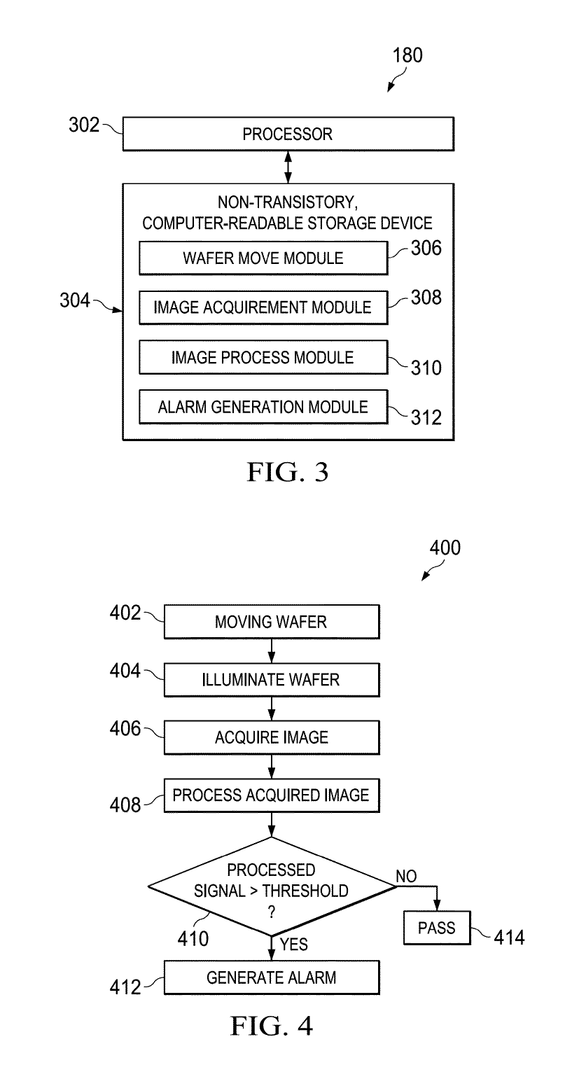

FIG. 3 shows a suitable example of an implementation of the defect detection engine 180 in which a processing unit 302 is coupled to a non-transitory, computer-readable storage device 304. The processing unit 302 may be a single processor, multiple processors, a single computer, multiple computers or any other type of processing unit. The non-transitory, computer-readable storage device 304 may be implemented as volatile storage (e.g., random access memory), non-volatile storage (e.g., hard disk drive, optical storage, solid-state storage, etc.) or combinations of various types of volatile and/or non-volatile storage.

As shown in FIG. 3, the non-transitory, computer-readable storage device 304 includes a wafer movement module 306, an image acquisition module 308, an image processing module 310, and an alarm generation module 312. Each module of FIG. 3 includes machine executable instructions and may be executed by the processing unit 302 to implement the functionality described herein. The functions to be implemented by executing the modules 306, 308, 310 and 312 will be described with reference to the flow diagram of FIG. 4. The defect detection engine 180 is defined to be processing unit 302 executing the modules in the storage device 304. That is, the defect detection engine 180 is not only software.

FIG. 4 shows a flow diagram for an illustrative method 400 implemented by, for example, the defect detection engine 180 in accordance with various implementations. As a result of executing the wafer movement module 306 by the processing unit 302, the wafer 150 attached to the support platform 104 is moved either in a linear motion or in a circular motion (402). The method 400 continues with block 404 to illuminate the wafer 150 by using a light source 108.

At block 406, the processor 302 executes the image acquirement module 308 to cause the camera 106 to acquire images of the moving wafer 150. In some embodiments, after acquiring all the images of the wafer 150, at block 408, the processor 302 may execute the image process module 310 to process all the acquired images, or the processor 302 may execute the image process module 310 immediately after each image is acquired by the camera 106.

The method 400 continues with block 410 by executing the image process module 310 to determine whether the processed signal is greater than the threshold (e.g., 250). More particularly, the defect detection engine 180 may determine whether a defect is present by examining each of the acquired images and determining, for each image, whether the processed signal for that image exceeds the threshold. For example, if there are total of 20 images which have been acquired for the wafer 150, the wafer 150 may be segmented into 20 areas, and each of the areas corresponds to a distinct area (e.g., 202 and 204) on the edges of the wafer 150. The defect detection engine 180 may examine each image as explained above.

Still referring to the method 400, if the defect detection engine 180 has determined at 410 that the processed signal is greater than the threshold, then control flows to block 412 in which the processing unit 302 executes the alarm generation module 312 to provide an alarm in order to notify a user that one or more areas on the wafer 150 include a defect. The alarm may be audible, visual, or a combination of audible and visual. Further, the alarm may be provided to a process control system coupled to the system 100 so that the process control system can perform a system-level configuration such as shutting down a particular equipment, holding an inventory, etc.

However, if the processed signal for a given image does not exceed the threshold, then that particular image and segment of the wafer passes at 414. If desired, a message may be presented to the user that no defect was detected in that image.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a support platform configured to support and move a wafer;
a light source configured to shine an illuminating light on the wafer;
a camera configured to acquire an image, using the illuminating light, of the wafer as it moves; and
a computing device coupled to the stage and the camera, the computing device configured to detect a defect of the wafer by processing the acquired image and determining whether a signal of the acquired image is greater than a threshold;
wherein upon detecting the presence of the defect, the computing device is configured to generate an alarm.

2. The system of claim 1, wherein the support platform is configured to move the wafer in a circular motion.

3. The system of claim 1, wherein the defect includes edge-chipping.

4. The system of claim 1, wherein the computing device is configured to process a plurality of images acquired by the camera by transforming the images into a distribution of a signal as a function of a corresponding location on the wafer.

5. The system of claim 4, wherein the signal indicates an intensity of reflected light from the wafer.

6. The system of claim 1, wherein the threshold is defined by the user.

7. The system of claim 1, wherein the camera includes an image sensor.

8. A method, comprising:
moving a wafer;
illuminating the wafer with a light source;
acquiring an image of the wafer being illuminated;
processing the image to provide a distribution of a signal as a function of a corresponding location of the wafer; and
detecting whether a processed signal corresponding to a location of the wafer is greater than a threshold.

9. The method of claim 8, wherein detecting that the processed signal is greater than the threshold, generating an alarm.

10. The method of claim 8, wherein acquiring the image includes using a camera to acquire the image based on diffusely reflected light from the wafer.

11. The method of claim 8, wherein moving the wafer includes moving the wafer in a circular motion.

12. The method of claim 9, wherein the threshold is defined by the user.

13. The method of claim 10, wherein the processed signal indicates an intensity of the diffusely reflected light from the wafer.

14. A non-transitory, computer readable storage device containing executable instructions that, when executed by a processor, causes the processor to:
move a wafer supported by a supporting platform;
acquire an image of the wafer via an camera;
process the acquired image to generate a distribution of a signal as a function of an associated location of the wafer;
detect a presence of a defect based on the generated signal at the associated location on the wafer being greater than a threshold; and
generate an alarm for the presence of the defect.

15. The non-transitory, computer readable storage device of claim 14 wherein executing the instruction causes the processor to move the wafer in a circular motion.

16. The non-transitory, computer readable storage device of claim 14 wherein executing the instruction causes the processor to acquire the image of the wafer based on light being diffusely reflected from the wafer.

17. The non-transitory, computer readable storage device of claim 14 wherein the defect is an edge-chipping.

18. The non-transitory, computer readable storage device of claim 16 wherein the generated signal indicates an intensity of the diffusely reflected light from the wafer.
